(19) United States
(12) Patent Application Publication
(10) Pub. No.: US 2009/0279553 A1
(43) Pub. Date: Nov. 12, 2009

(54) PROXY NODE DISCOVERING METHOD, AND RELAY NODE USED IN THE METHOD, AND, NODE DISCOVERING METHOD, AND FIRST NODE, SECOND NODE AND RELAY NODE USED IN THE METHOD

(75) Inventors: Takako Horu, Osaka (JP); Toyoki Ue, Osaka (JP); Hong Cheng, Tai Seng (SG)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/159,004

(22) PCT Filed: Dec. 27, 2006
(86) PCT No.: PCT/JP2006/326142

§ 371 Date: Aug. 18, 2008

(30) Foreign Application Priority Data
Dec. 27, 2005 (JP) 2005-374133
Jun. 7, 2006 (JP) 2006-159114
Dec. 25, 2006 (JP) 2006-348503

(51) Int. Cl. H04L 12/56

(52) U.S. Cl. 370/400

(57) ABSTRACT

A technology is disclosed that can provide a proxy node discovering method, a relay node used in the method, and the like, the method in which a proxy can be decided even when a local technology is not present between a data transmitter and the proxy or between an application and the proxy. The technology includes steps in which a first node 106 transmits towards a second node 100 a first message to which information indicating that discovery of a proxy node is requested is added. A relay node 108 that receives the first message judges whether the relay node 108 itself is a relay node positioned closest to the second node on a second path 112. The relay node judged to be closest transmits a second message to which information indicating that a relay node on a first path 110 adjacent to the relay node itself is being discovered is added. The relay node that has transmitted the second message acquires information identifying a relay node 102 that is first to receives the second message from the relay node that is first to receive the second message.

### TECHNICAL FIELD

The present invention relates to a proxy node discovering method and a relay node used in the method. The proxy node discovering method is used to discover a node adjacent to a data transmitting and receiving terminal that cannot process a certain signaling message, in a network in which data paths differ between data transmitting and receiving terminals that exchange data. In particular, the proxy node discovering method is used to decide a proxy node (proxy) that processes a certain signaling message as a proxy for a data transmitting and receiving terminal that cannot process the certain signaling message. The present invention also relates to a node discovering method and a first node, a second node, and a relay node used in the method. The node discovering method is used to discover a node that serves as a correspondence partner when one data transmitting and receiving terminal operates as a proxy for a data transmitting and receiving terminal that cannot process a certain signaling message.

### BACKGROUND ART

Next Steps In Signaling (NSIS) is becoming standardized as a new signaling protocol by a NSIS working group of the Internet Engineering Task Force (IETF) (refer to Non-patent Document 1 below). NSIS is expected to be particularly effective for Quality of Service (QoS) resource reservations. Recent internet drafts describe the necessity of and proposals regarding implementation of QoS signaling and mobility support in other NSIS (refer to Non-patent Documents 2 to 4 below), in addition to common NSIS (refer to Non-patent Documents 5 and 6 below). Although not all routers and terminals within a network are NSIS entities (NE), a NE has NSIS functions. Not all NE support QoS for mobility functions. Here, a NE having QoS functions is referred to as a QoS NE (QNE). A QoS resource is reserved at each QNE along a path through which data being transferred passes.

In NSIS such as this, when an additional service such as a QoS guarantee is provided, a path-coupled (or On-Path) signaling scheme is used. In the scheme, a NSIS signaling message (also referred to, hereinafter, as a signaling message) is sent over a same path as a path through which data sent from a data transmitter towards a data receiver passes. Each NSIS-supporting node (NE) present on the path processes the signaling message. When the data transmitter is a NE, as a result of the data transmitter transmitting the signaling message towards the data receiver, the signaling message passes through the same path as the data. When the data transmitter is not a NE, a NE present on the data path and closest to the data transmitter is required to become a proxy for the data transmitter and transmit the signaling message. When the proxy is used in NSIS, it is assumed that a local technology is present between the data transmitter and the proxy or between an application and the proxy. The proxy can transmit the signaling message through use of this technology (refer to Non-patent Document 5 below).

When the signaling message is transmitted, the NE stores information on adjacent NE as follows. When a first signaling message, among a series of signaling messages regarding a certain additional service, is transmitted from the data transmitter (or a transmitter-side proxy) towards the data receiver (or a data receiver-side proxy), each NE intercepts the signaling message because of a router alert option (RAO) added to a header of the signaling message. Each NE processes the signaling message and, at the same time, exchanges information with the adjacent NE (refer to Non-patent Document 6 below).

When the data receiver is not a NE, a NE on the data path and closest to the data receiver can become the data receiver-side proxy because, when the first signaling message is transmitted from the data transmitter (or the data transmitter-side proxy), a last NE on the path does not have an adjacent NE in a signaling message transmitting direction (downstream direction). Therefore, the NE can detect that the NE itself is the last NE on the data path and act as the proxy.

In NSIS, when the data transmitter is not a NE, it is assumed that a local technology is present between the data transmitter and the proxy or between the application and the proxy. The proxy can transmit the signaling message through use of this technology. However, when the local technology is not present can also be considered. When the local technology is not present, the signaling message cannot be transmitted from the data transmitter side. However, when the data receiver is a NE and desires an additional service using NSIS for the data sent from the data transmitter can also be considered. In this case, the NE that is the data receiver is required to discover the proxy on the data transmitter side and request that the proxy send the signaling message.

Non-patent Document 1: NSIS WG (http://www.ietf.org/html.charters/nsis-charter.html)

### Non-patent Document 2: H. Chaskar, Ed, “Requirements of a Quality of Service (QoS) Solution for Mobile IP”, RFC 3583, September 2003

Non-patent Document 3: Sven Van den Bosch, Georgios Karagiannis and Andrew McDonald, “NSLP for Quality-of-Service signaling”, draft-ietf-nsis-qos-nslp-06.txt, May 2005
Non-patent Document 4: S. Lee, et al., “Applicability Statement of NSIS Protocols in Mobile Environments”, draft-ietf-nsis-applicability-mobility-signaling-01.txt, February 2005
Non-patent Document 5: R. Hancock (editor), “Next Steps in Signaling: Framework”, RFC 4080, June 2005
Non-patent Document 6: H. Schulzrinne and R. Hancock, “GIMPS: General Internet Messaging Protocol for Signaling”, draft-ietf-nsis-ntlp-07 (work in progress), July 2005
Non-patent Document 7: T. Sanda, T. Ue, and H. Cheng, “Path type support for NSIS signaling”, draft-sanda-nsis-path-type-02.txt, February 2005

However, there are instances in which a path for data and signaling messages sent from the data transmitter side to the data receiver side and a path for signaling messages sent from the data receiver side to the data transmitter side differ. Therefore, the proxy on the data transmitter side is difficult to discover through transmission of a signaling message of some sort from the NE that is the data receiver towards the data transmitter side. This is explained with reference to FIG. 16. As shown in FIG. 16, a data communication system is configured by a terminal 1600 that is not a NE, a terminal 1606 that is a NE, a NE 1602, a NE 1604, and a NE 1608. Data transmitted from the terminal 1600 that is the data transmitter to the terminal 1606 is sent to the terminal 1606 over a path 1610, namely via the NE 1602 and the NE 1604. At the same time, data transmitted from the terminal 1606 towards the terminal 1600 is sent to the terminal 1600 over a path 1612, namely via the NE 1604 and the NE 1608.

For example, the data is now being sent from the terminal 1600 towards the terminal 1606. The terminal 1606 that is the data receiver and a NE desires an additional service using the NSIS. In this case, a NE closest to the terminal 1600 on the path 1610, namely the NE 1602, is required to become the proxy and transmit a signaling message to the terminal 1606. However, when the terminal 1606 transmits a signaling message towards the terminal 1600 to discover the NE 1602, the signaling message passes over the same path 1612 as a data path from the terminal 1606 to the terminal 1600. Therefore, the signaling message cannot be sent via the NE 1602, and the NE 1602 cannot be detected as the proxy. When the terminal 1606 transmits a loop-back type signaling message that returns to the terminal 1606 itself via the terminal 1600, the signaling message can pass through the NE 1602 because the signaling message reaches the terminal 1606 using the path 1610 after passing through the path 1612. However, the terminal 1606 does not have a means to recognize which NE is the NE closest the terminal 1600 on the path 1610. Therefore, the proxy cannot be decided.

Most path-coupled signaling schemes assume that a communication end point (a data transmitting and receiving terminal such as a correspondent node [CN] and a mobile node [MN], described hereafter) of a data traffic can recognize signaling (signaling-aware node). However, with increasing polarity of mobile computing, this assumption is no longer a certainty. In mobile computing, an ordinary communication end point is a mobile device. These mobile devices ordinarily have limited calculation power, memory, and battery life unique to mobiles. As a result, applications and operating systems processed by these mobiles are required to be light in load. Therefore, it is not preferable for the devices to support a signaling scheme requiring special packet processing and a special signaling state.

A case in which a legacy device is used as the end point can be considered as an example of a case in which the end point is not a signaling-aware node. In the legacy device, supporting a signaling scheme means to upgrade an operating system or related hardware. This is not possible because of different disposal environments. It is also not possible to have an upgraded device every time a new signaling characteristic is added to the scheme.

As described above, another node that operates as a proxy for the communication end node is required. However, this approach is confronted with asymmetry of network routing. A data path from the terminal (CN) 1606 to the terminal (MN) 1600 may differ from a data path from the terminal (MN) 1600 to the terminal (CN) 1606. This becomes a problem in the path-coupled signaling scheme. No node other than the terminal (MN) 1600 can accurately identify an actual data path. Therefore, the signaling-aware node closest to the terminal (MN) 1600 cannot be identified.

### DISCLOSURE OF THE INVENTION

In light of the above-described problems, an object of the present invention is to provide a proxy node discovering method, and a relay node used in the method, and, a node discovering method, and a first node, a second node and a relay node used in the method. In the proxy node discovering method, a proxy (proxy node) can be decided without a local technology being present between a data transmitter and the proxy or between an application and the proxy. In the node discovering method, a node adjacent to a data transmitter can be decided even when a local technology is not present between the data transmitter and the adjacent node.

To achieve the above-described object, the present invention provides a proxy node discovering method that is a proxy node discovering method in which, in a data communication system including a first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a proxy node positioned on the first path that processes the message having the predetermined property as a proxy for the second node is discovered. The proxy node discovering method includes a step at which the first node transmits a first message towards the second node. The first message is the message having the predetermined property to which information indicating that discovery of the proxy node is requested is added. The proxy node discovering method also includes a step at which the relay node that has received the first message judges whether the relay node itself is a relay node positioned closest to the second node on the second path. The proxy node discovering method also includes a step at which the relay node that has judged that the relay node itself is the relay node positioned closest to the second node on the second path transmits a second message via the second node. The second message is the message having the predetermined property to which information indicating that a relay node adjacent to the relay node itself on the first path is being discovered is added. The proxy node discovering method also includes a step at which the relay node that has transmitted the second message acquires information identifying a relay node that is first to receive the transmitted second message from the relay node that is first to receive the second message. As a result of the configuration, the proxy can be decided even when a local technology is not present between a data transmitter and the proxy or between an application and the proxy. “Positioned closest to the second node on the second path” is synonymous with “first on the second path when viewed from the second node”.

In addition, in the proxy node discovering method of the present invention, a preferred aspect of the present invention is that the first message is a message indicating that discovery of a relay node positioned closest to the second node on the first path and that can process the message having the predetermined property is requested. The first message includes address information of the second node. As a result of the configuration, the first message can arrive at the second node via the second path.

In addition, in the proxy node discovering method of the present invention, a preferred aspect of the present invention is that the relay node that transmits the second message or the relay node that is first to receive the second message transmits a third message to the first node. The third message is the message having the predetermined property to which information identifying the relay node that is first to receive the second message is added. As a result of the configuration, the first node can know the proxy node.

In addition, in the proxy node discovering method of the present invention, a preferred aspect of the present invention is that the first message is a message indicating that discovery of a relay node positioned closest to the second node on the first path and that can process the message having the predetermined property is requested. The first message is also a message indicating that a QoS resource reservation on the first path is requested of the discovered relay node. The first message includes at least one or more among address information of the second node, address information of the first node, and information on the QoS resource reserved on the first path. As a result of the configuration, the relay node serving as the proxy node can reserve the QoS resource on the first path.

In addition, in the proxy node discovering method of the present invention, a preferred aspect of the present invention is that the second message is a message indicating that a QoS resource reservation on the first path is requested of the relay node that is first to receive the second message. The second message includes at least one or more between address information of the first node and information on the QoS resource reserved on the first path. As a result of the configuration, the relay node serving as the proxy node can reserve the QoS resource on the first path.

In addition, in the proxy node discovering method of the present invention, a preferred aspect of the present invention is that the first message and the second message include information used to allow a relay node that can process the message having the predetermined property to receive the first message and the second message. As a result, the relay node that can process the message having the predetermined property can receive the message with certainty.

In addition, in the proxy node discovering method of the present invention, a preferred aspect of the present invention is that, when the second node performs a handover after the proxy node is discovered, the proxy node at a destination of the handover can be rediscovered. As a result of the configuration, communication can be continued at the handover destination even when the handover is performed.

The present invention provides a relay node that is a relay node that, in a data communication system including a first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, can process the message having the predetermined property. The relay node includes a receiving means that receives a first message transmitted from the first node. The first message is the message having the predetermined property to which information indicating that discovery of the proxy node is requested is added. The relay node also includes a judging means that judges whether the relay node itself is a relay node positioned closest to the second mode on the second path, based on the received first message. The relay node also includes a message generating means that, when the relay node itself is judged to be the relay node positioned closest to the second node on the second path, generates a second message. The second message is the message having the predetermined property to which information indicating that a relay node adjacent to the relay node itself on the first path is being discovered is added. The relay node also includes a transmitting means that transmits the generated second message via the second node. The relay node also includes an acquiring means that acquires information identifying a relay node that is first to receive the transmitted second message from the relay node that is first to receive the second message. As a result of the configuration, the proxy can be decided even when a local technology is not present between a data transmitter and the proxy or between an application and the proxy.

In addition, in the relay node of the present invention, a preferred aspect of the present invention is that the first message is a message indicating that discovery of a relay node positioned closest to the second node on the first path and that can process the message having the predetermined property is requested. The first message includes address information of the second node. As a result of the configuration, the first message can arrive at the second node via the second path.

In addition, in the relay node of the present invention, a preferred aspect of the present invention is that the acquiring means acquires information related to the relay node that is first to receive the second message from the relay node that is first to receive the second message. The message generating means generates a third message that is the message having the predetermined property to which the acquired information identifying the relay node is included. The transmitting means transmits the generated third message to the first node. As a result of the configuration, the first node can know the proxy node.

In addition, in the relay node of the present invention, a preferred aspect of the present invention is that the first message is a message indicating that discovery of a relay node positioned closest to the second node on the first path and that can process the message having the predetermined property is requested. The first message is also a message indicating that a QoS resource reservation on the first path is requested of the discovered relay node. The first message includes at least one or more among address information of the second node, address information of the first node, and information on the QoS resource reserved on the first path. As a result of the configuration, the relay node serving as the proxy node can reserve the QoS resource on the first path.

In addition, in the relay node of the present invention, a preferred aspect of the present invention is that the second message is a message indicating that a QoS resource reservation on the first path is requested of the relay node that is first to receive the second message. The second message includes at least one or more between address information of the first node and information on the QoS resource reserved on the first path. As a result of the configuration, the relay node serving as the proxy node can reserve the QoS resource on the first path.

In addition, in the relay node of the present invention, a preferred aspect of the present invention is that the first message and the second message include information used to allow a relay node that can process the message having the predetermined property to receive the first message and the second message. As a result, the relay node that can process the message having the predetermined property can receive the message with certainty.

The present invention provides a node discovering method that is a node discovering method in which, in a data communication system including a first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a node positioned closest to the second node on the first path and that can process the message having the predetermined property is discovered. The node discovering method includes a step at which the first node transmits a message towards the second node. The message used to discover the node positioned closest to the second node on the first path. The node discovering method also includes a step at which the first node receives, based on the message transmitted via the second node, information identifying the node positioned closest to the second node on the first path included in a message transmitted from the node itself. As a result of the configuration, a node (relay node) adjacent to a data transmitter (second node) can be decided even when a local technology is not present between the data transmitter and the adjacent node.

The present invention provides a node discovering method that is a node discovering method in which, in a data communication system including a first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a node positioned closest to the second node on the first path and that can process the message having the predetermined property is discovered. The node discovering method includes a step at which the first node transmits a first message towards the second node. The first message proposes that the first node itself become a proxy node operating as a proxy for the second node. The node discovering method also includes a step at which, when the first node is accepted as the proxy node based on the received first message, the second node transmits a portion of the received first message towards the first node as a second message. The node discovering method also includes a step at which the relay node that has received the second message transmitted by the second node includes information used to identify the relay node itself in the second message and transmits the second message towards the first node. As a result of the configuration, a node (relay node) adjacent to a data transmitter (second node) can be decided even when a local technology is not present between the data transmitter and the adjacent node.

In addition, in the node discovering method of the present invention, a preferred aspect of the present invention is that the first message includes at least address information of the second node as a transmitting source address, address information of the first node as a transmitting destination address, and address information of a node that is an actual transmitting source. The first message is encapsulated by predetermined header information. As a result of the configuration, the message can be appropriately transmitted.

In addition, in the node discovering method of the present invention, a preferred aspect of the present invention is that the second node removes the predetermined header information in the first message and transmits remaining first message towards the first node as the second message. As a result of the configuration, the node to be discovered that is adjacent the second node can be discovered.

In addition, in the node discovering method of the present invention, a preferred aspect of the present invention is that the relay node that has received the second message acquires address information of a hop node that is an adjacent node on the first path that has transmitted the second message, based on the address information of the node that is the actual transmitting source included in the second message. The relay node changes the address information of the node that is the actual transmitting source included in the second message to address information of the relay node itself. As a result of the configuration, an adjacent node in a direction opposite of a message flow can be known.

In addition, in the node discovering method of the present invention, a preferred aspect of the present invention is that when the second node moves, the first node transmits the first message again to towards the second node. As a result of the configuration, a new path can be established even after movement.

The present invention provides a first node that is a first node that is used in a node discovering method in which, in a data communication system including the first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a node positioned closest to the second node on the first path and that can process the message having the predetermined property is discovered. The first node includes a message generating means that generates a first message used to propose that the first node itself become a proxy node operating as a proxy for the second node. The first node also includes a transmitting means that transmits the generated first message towards the second node. As a result of the configuration, a node (relay node) adjacent to a data transmitter (second node) can be decided even when a local technology is not present between the data transmitter and the adjacent node.

In addition, in the first node of the present invention, a preferred aspect of the present invention is that the first message includes at least address information of the second node as a transmitting source address, address information of the first node as a transmitting destination address, and address information of a node that is an actual transmitting source. The first message is encapsulated by predetermined header information. As a result of the configuration, the message can be appropriately transmitted.

In addition, in the first node of the present invention, a preferred aspect of the present invention is that, when the second node moves, the transmitting means transmits the first message again towards the second node. As a result of the configuration, a new path can be established even after movement.

The present invention provides a second node that is a second node that is used in a node discovering method in which, in a data communication system including a first node that transmits and receives data, the second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a node positioned closest to the second node on the first path and that can process the message having the predetermined property is discovered. The second node includes a receiving means that receives a first message transmitted by the first node proposing that the first node become a proxy node operating as a proxy for the second node. The second node also includes a processing means that, when the first node is accepted as the proxy node based on the received first message, processes a portion of the received first message into a second message. The second node also includes a transmitting means that transmits the processed second message towards the first node. As a result of the configuration, a node (relay node) adjacent to a data transmitter (second node) can be decided even when a local technology is not present between the data transmitter and the adjacent node.

In addition, in the second node of the present invention, a preferred aspect of the present invention is that the first message includes at least address information of the second node as a transmitting source address, address information of the first node as a transmitting destination address, and address information of a node that is an actual transmitting source. The first message is encapsulated by predetermined header information. As a result of the configuration, the message can be appropriately transmitted.

In addition, in the second node of the present invention, a preferred aspect of the present invention is that the processing means removes the predetermined header information in the first message and generates the second message. As a result of the configuration, the node to be discovered that is adjacent to the second node can be discovered.

In addition, in the second node of the present invention, a preferred aspect of the present invention is that, when the second node itself moves, the transmitting means transmits a message towards the first node giving notification that the second node itself has moved, to receive the first message again from the first node. As a result of the configuration, a new path can be established even after movement.

The present invention provides a relay node that is a relay node used in a node discovering method in which, in a data communication system including a first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a node positioned closest to the second node on the first path that can process the message having the predetermined property is discovered. The relay node includes a receiving means that receives a second message transmitted by the second node. The second message is a portion of a first message from the first node proposing to become a proxy node operating as a proxy for the second node. The relay node also includes a message generating means that includes information used to identify the relay node itself in the received second message. The relay node also includes a transmitting means that transmits the generated second message towards the first node. As a result of the configuration, anode (relay node) adjacent to a data transmitter (second node) can be decided even when a local technology is not present between the data transmitter and the adjacent node.

In addition, in the relay node of the present invention, a preferred aspect of the present invention is that the first message includes at least address information of the second node as a transmitting source address, address information of the first node as a transmitting destination address, and address information of a node that is an actual transmitting source. The first message is encapsulated by predetermined header information. As a result of the configuration, the message can be appropriately transmitted.

In addition, in the relay node of the present invention, a preferred aspect of the present invention is that, based on the address information of the node that is the actual transmitting source included in the second message, address information of a hop node that is an adjacent node on the first path that has transmitted the second message is acquired and the address information of the node that is the actual transmitting source included in the second message is changed to address information of the relay node itself. As a result of the configuration, a node adjacent in a direction opposite of a message flow can be known.

The proxy node discovering method and the relay node used in the method of the present invention are configured as described above. The proxy (proxy node) can be decided even when a local technology is not present between the data transmitter and the proxy or between the application and the proxy. The node discovering method and the first node, the second node, and the relay node used in the method of the present invention are configured as described above. The node (relay node) adjacent to the data transmitter (second node) can be decided even when a local technology is not present between the data transmitter and the adjacent node.

### BRIEF DESCRIPTION OF THE DRAWINGS

FIG. 1 is a block diagram of a configuration of a data communication system according to a first embodiment of the present invention;

FIG. 2 is a sequence chart used to explain a proxy node discovering method (signaling proxy discovering method) according to the first embodiment of the present invention;

FIG. 3 is a block diagram of a configuration of a relay node according to the first embodiment of the present invention;

FIG. 4 is a block diagram of a configuration of a data communication system according to a second embodiment of the present invention;

FIG. 5 is a sequence chart used to explain a proxy node discovering method (signaling proxy discovering method) and a QoS resource reservation according to the second embodiment of the present invention;

FIG. 6 is a block diagram of a configuration of a relay node according to the second embodiment of the present invention;

FIG. 7 is a block diagram of a configuration of a data communication system according to a third embodiment of the present invention;

FIG. 8 is a block diagram of a configuration of a mobile node (MN) according to the third embodiment of the present invention;

FIG. 9 is a block diagram of a configuration of a correspondent node (CN) according to the third embodiment of the present invention;

FIG. 10 is a block diagram of a configuration of a relay node (QNE) according to the third embodiment of the present invention;

FIG. 11 is a sequence chart used to explain a node discovering method according to the third embodiment of the present invention;

FIG. 12 is a block diagram of a configuration of a data communication system according to a fifth embodiment of the present invention;

FIG. 13 is a block diagram of a configuration of a data communication system according to a first pattern of a sixth embodiment of the present invention;

FIG. 14 is a block diagram of a configuration of a data communication system according to a second pattern of the sixth embodiment of the present invention;

FIG. 15 is a block diagram of a configuration of a data communication system according to a third pattern of the sixth embodiment of the present invention; and

FIG. 16 is a block diagram of a configuration of a conventional data communication system.

### BEST MODE FOR CARRYING OUT THE INVENTION

### First Embodiment

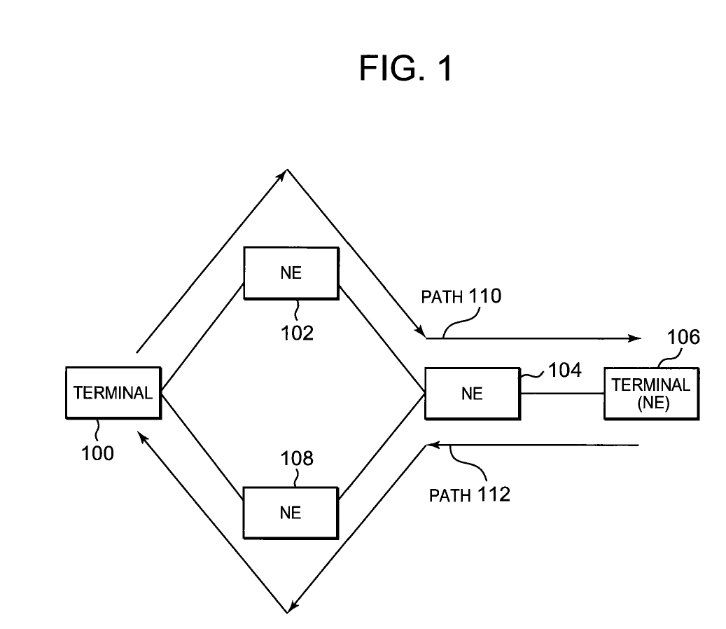

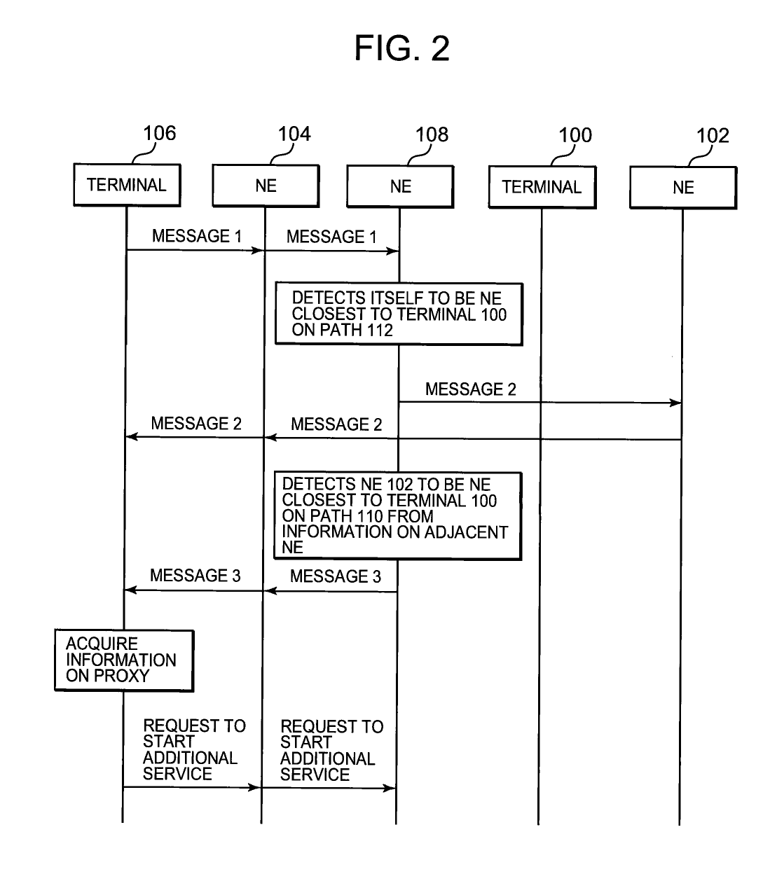

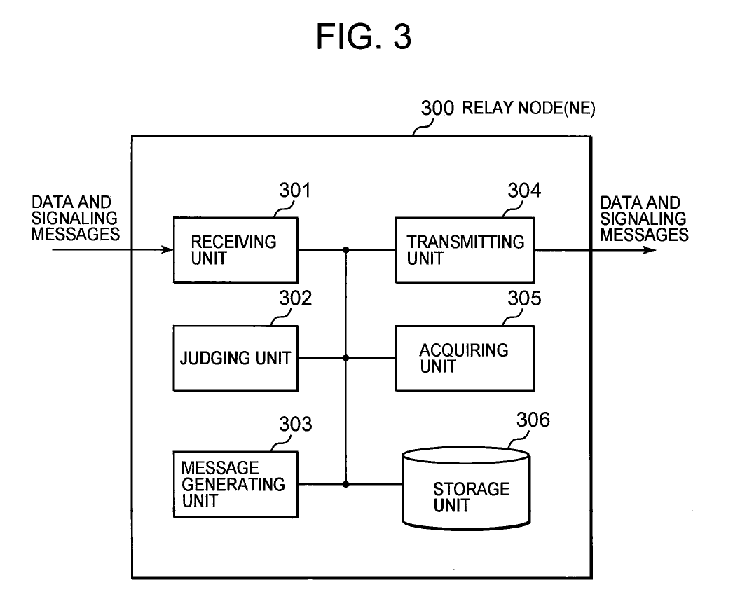

A first embodiment of the present invention will be described hereafter with reference to FIG. 1 to FIG. 3. FIG. 1 is a block diagram of a configuration of a data communication system according to the first embodiment of the present invention. FIG. 2 is a sequence chart used to explain a proxy node discovering method (signaling node discovering method) according to the first embodiment of the present invention. FIG. 3 is a block diagram of a configuration of a relay node according to the first embodiment of the present invention.

First, a signaling proxy discovering method according to the first embodiment of the present invention will be described with reference to FIG. 1 and FIG. 2. Here, a proxy discovering method regarding an additional service using NSIS will be described. However, the proxy discovering method can also be applied to a technology using other signaling messages, such as resource reservation protocol (RSVP). According to the first embodiment of the present invention, a terminal 100, described hereafter, also has an ordinary router function. As shown in FIG. 1, a terminal (NE) 106 performs a following operation to decide a data transmitter-side proxy when an additional service using NSIS is desired for data sent from the terminal 100.

First, the terminal 106 transmits a signaling message towards the terminal 100 to discover a NE closest to the terminal 100 on a path 112, namely a NE 108. The signaling message (also referred to, hereinafter, as message 1) has information meaning “discover a NE (also referred to as a proxy node) closest to the terminal 100 on a path 110” and address information of the terminal 100. The message 1 can be a NSIS signaling message expanded for use according to the first embodiment of the present invention. Alternatively, the message 1 can be a newly defined signaling message. However, the message 1 is required to have a function allowing only each NE to receive the message 1 (for example, a RAO is added) and a function allowing the NE that has received the message 1 to know adjacent NE on a path over which the message 1 is sent. The message 1 is transmitted over the path 112.

A NE adjacent to the NE 108 in a transmitting direction (downstream direction) of the message 1 on the path 112 is not present. Therefore, the NE 108 judges that the NE 108 itself is the NE closest to the terminal 100 on the path 112. Next, the NE 108 transmits a signaling message (also referred to, hereinafter, as message 2) to which information indicating that the NE 108 is searching (discovering) to discover the NE closest to the terminal 100 on the path 110 is added. The NE 108 transmits the message 2 towards the terminal 106, via the terminal 100. To transmit the message 2 via the terminal 100, for example, strict route that is a pre-existing internet protocol [IP] technology and the like can be used. The message 2 can be a NSIS signaling message expanded for use according to the first embodiment of the present invention. Alternatively, the message 2 can be a newly defined signaling message. However, the message 2 is required to have a function allowing only each NE to receive the message 2 (for example, a RAO is added) and a function allowing the NE that has received the message 2 to know adjacent NE on a path over which the message 2 is sent. The message 2 passes through the path 112 and is sent to the terminal 106 over the path 110, once the message 2 passes through the terminal 100.

The NE 108 obtains information on the adjacent NE in the signaling message transmitting direction, namely a NE 102. A NE is not present between the NE 108 and the terminal 100 on the path 112. Therefore, it is clear that the adjacent NE is the NE closest to the terminal 100 on the path 110. The proxy is discovered in this way. The terminal 106 is notified of the information on the discovered proxy through a signaling message (also referred to, hereinafter, as message 3). The message 3 can be transmitted from the NE 108. Alternatively, the message 3 can be transmitted from the NE 102. The message 3 can be a NSIS signaling message expanded for use according to the first embodiment of the present invention. Alternatively, the message 3 can be a newly defined signaling message. The terminal 106 that has received the message 3 transmits a request message to the proxy (NE 102) requesting that a signaling message for the additional service be transmitted. The request message can be a NSIS signaling message expanded for use according to the first embodiment of the present invention. Alternatively, the request message can be a newly defined signaling message.

Next, a relay node according to the first embodiment of the present invention will be described with reference to FIG. 3. The relay node described here is a relay node (NE) that can process a NSIS signaling message and is, for example, the NE 108. As shown in FIG. 3, a relay node (NE) 300 includes a receiving unit 301, a judging unit 302, a message generating unit 303, a transmitting unit 304, an acquiring unit 305, and a storage unit 306. The receiving unit 301 receives data, signaling messages, and the like exchanged between the terminal 100 and the terminal 106. For example, the receiving unit 301 receives the message 1 used to discover the proxy node, transmitted from the terminal 106.

The judging unit 302 judges whether the relay node 300 itself is the relay node positioned closest to the terminal 100 on the path 112, based on the received message 1. In other words, the judging unit 302 judges that the relay node 300 itself is the NE closest to the terminal 100 on the path 112 because no NE adjacent in the transmitting direction (downstream direction) of the message 1 is present on the path 112. When the judging unit 302 judges that the relay node 300 is the relay node positioned closest to the terminal 100 on the path 112, the message generating unit 303 generates the message 2 for discovering the relay node on the path 110 adjacent the relay node 300 itself. The message 2 can be a NSIS signaling message expanded for use according to the first embodiment of the present invention. Alternatively, the message 2 can be a newly defined signaling message. However, the message 2 is required to have a function allowing only each NE to receive the message 2 (for example, a RAO is added) and a function allowing the NE that has received the message 2 to know an adjacent NE on the path over which the message 2 is sent.

The transmitting unit 304 transmits data, signaling messages, and the like exchanged between the terminal 100 and the terminal 106. For example, the transmitting unit 304 transmits the generated message 2 towards the terminal 106 via the terminal 100. To transmit the message 2 via the terminal 100, for example, strict route that is a pre-existing IP technology and the like can be used. The acquiring unit 305 acquires information related to the relay node that is the first to receive the message 2 transmitted by the transmitting unit 304 from the relay node that is the first to receive the message 2. A NE is not present between the NE 108 and the terminal 100 on the path 112. Therefore, it is clear that the NE adjacent to the relay node 300 is the NE closest to the terminal 100 on the path 110. The proxy is discovered in this way. The transmitting unit 304 can transmit the message 3 including the information on the discovered proxy to the terminal 106. The message 3 can be a NSIS signaling message expanded for use according to the first embodiment of the present invention. Alternatively, the message 2 can be a newly defined signaling message. The storage unit 306 stores information generated by processes performed by the relay node 300. The storage unit 306 also stores control programs and the like for controlling operation of the relay node 300.

### Second Embodiment

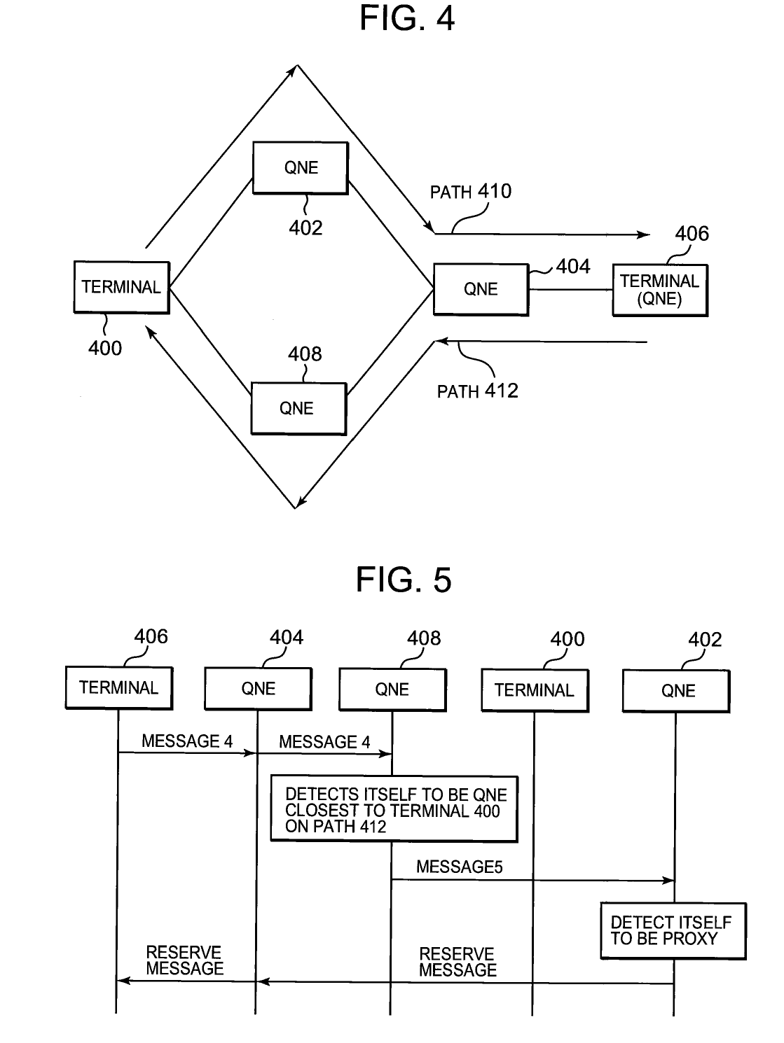

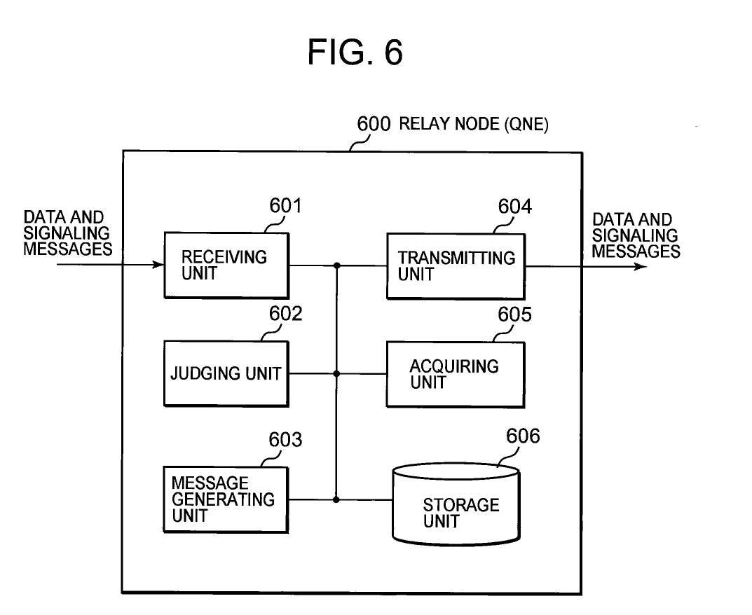

Hereafter, a second embodiment of the present invention will be described with reference to FIG. 4 to FIG. 6. FIG. 4 is a block diagram of a configuration of a data communication system according to a second embodiment of the present invention. FIG. 5 is a sequence chart used to explain a proxy node discovering method (signaling proxy discovering method) and a QoS resource reservation according to the second embodiment of the present invention. FIG. 6 is a block diagram of a configuration of a relay node according to the second embodiment of the present invention. According to the second embodiment of the present invention, a terminal 400, described hereafter, has an ordinary router function.

According to the second embodiment of the present invention, the proxy starts transmission of the signaling message for the additional service without notifying the terminal 106 of the information on the discovered proxy (proxy node) according to the first embodiment. An example of the method will be described with reference to FIG. 4 and FIG. 5. The additional service using NSIS, here, is a QoS guarantee using NSIS QoS NSIS signaling layer protocol (NSLP: a protocol for generating a signaling message for providing an additional service and processing the signaling message). A QNE 402, a QNE 404, a QNE 408, and a terminal 406 are NE having the QoS NSLP function, namely QNE. However, the second embodiment of the present invention can be applied not only to additional services using NSIS in addition to the QoS guarantee, but also to other signaling technologies such as RSVP.

The terminal 406 transmits a signaling message (also referred to, hereinafter, as message 4) towards the terminal 400 when the QoS guarantee using NSIS is desired for data sent from the terminal 400. The message 4 has information meaning “discover a QNE closest to the terminal 400 on a path 410 and request that the QNE (proxy) reserve a QoS resource on the path 410”. The message 4 has information required for the proxy to reserve the QoS resource on the path 410 (address information of the terminal 406, information on the desired QoS resource, and the like), in addition to the address information of the terminal 400. A session identifier (ID) to be used can also be included as the information required for the proxy to reserve the QoS resource on the path 410. The message 4 is transmitted over a path 412. The message 4 can be a NSIS signaling message expanded for use according to the second embodiment of the present invention. Alternatively, the message 4 can be a newly defined signaling message. However, the message 4 is required to have a function allowing only each QNE to receive the message 4 (for example, a RAO is added) and a function allowing the QNE that has received the message 4 to know adjacent QNE on a path over which the message 4 is sent.

A QNE adjacent to the QNE 408 in the transmitting direction (downstream direction) of the signaling message on the path 412 is not present. Therefore, the QNE 408 judges that the QNE 408 itself is the QNE closest to the terminal 400 on the path 412. Next, the QNE 408 transmits a signaling message (also referred to, hereinafter, as message 5) towards the terminal 406, via the terminal 400. The message 5 has information meaning “first QNE (proxy) to receive this message will reserve a desired QoS resource on the path 410”. To transmit the signaling message via the terminal 400, for example, strict route that is a pre-existing internet protocol [IP] technology and the like can be used. The message 5 has information required for the proxy to perform a QoS resource reservation on the path 410 (address information of the terminal 406, information on the desired QoS resource, and the like). The information is copied from the above-described message 4. The message 5 is sent to the terminal 406 over the path 410 once the message 5 passes through the terminal 400. Alternatively, the first QNE (QNE 402) to receive the message 5 stops the message 5 and the message 5 is not transmitted any further.

The message 5 can be a NSIS signaling message expanded for use according to the second embodiment of the present invention. Alternatively, the message 5 can be a newly defined signaling message. However, the message 5 is required to have a function allowing only each QNE to receive the message 5 (for example, a RAO is added). According to the second embodiment, the proxy starts transmission of the signaling message for the additional service. Therefore, the QNE that has received the signaling message is not necessarily required to have a function to know the adjacent QNE.

The QNE 402 that has received the message 5 detects that the QNE 402 itself is the proxy. The QNE 402 transmits a RESERVE message that is a QoS NSLP message to the terminal 406, thereby reserving the QoS resource on the path 410. When the message 5 does not include the session ID, the QNE 402 generates the session ID. Rather than the QNE 402 sending the RESERVE message to the terminal 406, the QNE 402 can send a QUERY message that is a QoS NSLP message. As a result, a receiver-initiated QoS reservation is performed from the terminal 406.

Next, a relay node according to the second embodiment of the present invention will be described with reference to FIG. 6. The relay node described here is a relay node (QNE) having a QoS NSLP function and is, for example, the QNE 408. As shown in FIG. 6, a relay node (QNE) 600 includes a receiving unit 601, a judging unit 602, a message generating unit 603, a transmitting unit 604, an acquiring unit 605, and a storage unit 606. The receiving unit 601 receives data, signaling messages, and the like exchanged between the terminal 400 and the terminal 406. For example, the receiving section 601 receives the message 4 having the information meaning “discover the QNE closest to the terminal 400 on the path 410 and request that the QNE (proxy) reserve the QoS resource on the path 410”, transmitted from the terminal 406.

The message 4 has the information required for the proxy to reserve the QoS resource on the path 410 (address information of the terminal 406, information on the desired QoS resource, and the like), in addition to the address information of the terminal 400. The session identifier (ID) to be used can also be included as the information required for the proxy to reserve the QoS resource on the path 410. The message 4 can be a NSIS signaling message expanded for use according to the second embodiment of the present invention. Alternatively, the message 4 can be a newly defined signaling message. However, the message 4 is required to have a function allowing only each QNE to receive the message 4 (for example, a RAO is added) and a function allowing the QNE that has received the message 4 to know the adjacent QNE on a path over which the message 4 is sent.

The judging unit 602 judges whether the relay node 600 itself is the relay node positioned closest to the terminal 400 on the path 412, based on the received message 4. In other words, the judging unit 602 judges that the relay node 600 itself is the QNE closest to the terminal 400 on the path 412 because no QNE adjacent in the transmitting direction (downstream direction) of the message 4 is present on the path 412. When the judging unit 602 judges that the relay node 600 is the relay node positioned closest to the terminal 400 on the path 412, the message generating unit 603 generates the message 5 for discovering the relay node on the path 410 adjacent the relay node 600 itself. Specifically, the message 5 is a signaling message having the information meaning “first QNE (proxy) to receive this message will reserve the desired QoS resource on the path 410”. The message 5 has information required for the proxy to perform the QoS resource reservation on the path 410 (address information of the terminal 406, information on the desired QoS resource, and the like). The information is copied from the above-described message 4.

The message 5 can be a NSIS signaling message expanded for use according to the second embodiment of the present invention. Alternatively, the message 5 can be a newly defined signaling message. However, the message 5 is required to have a function allowing only each QNE to receive the message 5 (for example, a RAO is added). According to the second embodiment, the proxy starts transmission of the signaling message for the additional service. Therefore, the QNE that has received the signaling message is not necessarily required to have a function to know the adjacent QNE.

The transmitting unit 604 transmits data, signaling messages, and the like exchanged between the terminal 400 and the terminal 406. For example, the transmitting unit 604 transmits the generated message 5 towards the terminal 406 via the terminal 400. To transmit the message 5 via the terminal 400, for example, strict route that is a pre-existing IP technology and the like can be used. The message 5 is sent to the terminal 406 over the path 410 once the message 5 passes through the terminal 400. Alternatively, the first QNE (QNE 402) to receive the message 5 stops the message 5 and the message 5 is not transmitted any further. The acquiring unit 605 is optional. The acquiring unit 605 acquires information related to the relay node that is the first to receive the message 5 transmitted by the transmitting unit 604 from the relay node that is the first to receive the message 5. A QNE is not present between the QNE 408 and the terminal 400 on the path 412. Therefore, it is clear that the QNE adjacent to the relay node 600 is the QNE closest to the terminal 400 on the path 410. The storage unit 606 stores information generated by processes performed by the relay node 600. The storage unit 606 also stores control programs and the like for controlling operation of the relay node 600.

According to the above-described first embodiment and second embodiment, when the terminal 100 and the terminal 400 are mobile nodes and connected to a network via access points (not shown) and access routers (not shown) provided beyond the access points, route points of the message 2 and the message 5 can be the access routers connected to the terminal 100 and the terminal 400, rather than the terminal 100 and the terminal 400. In this case, the terminal 100 and the terminal 400 are not particularly required to have router functions.

As described above, when the terminal 100 and the terminal 400 are mobile nodes and connected to the network via the access points (not shown) and the access routers (not shown) provided beyond the access points, for example, the terminal 100 or the terminal 400 performs a handover to a sub-network under an access router (referred to as a second access router) other than the access router used for network connection at this time. In this case, before the terminal 100 or the terminal 400 performs handover, if the terminal 106 or the terminal 406 knows the IP address of the second access router, the terminal 106 or the terminal 406 transmits the message 1 or the message 4 to the second access router. As a result, a proxy closest to the second access router in a direction from the second access router to the terminal 106 or the terminal 406 can be discovered in advance.

### Third Embodiment

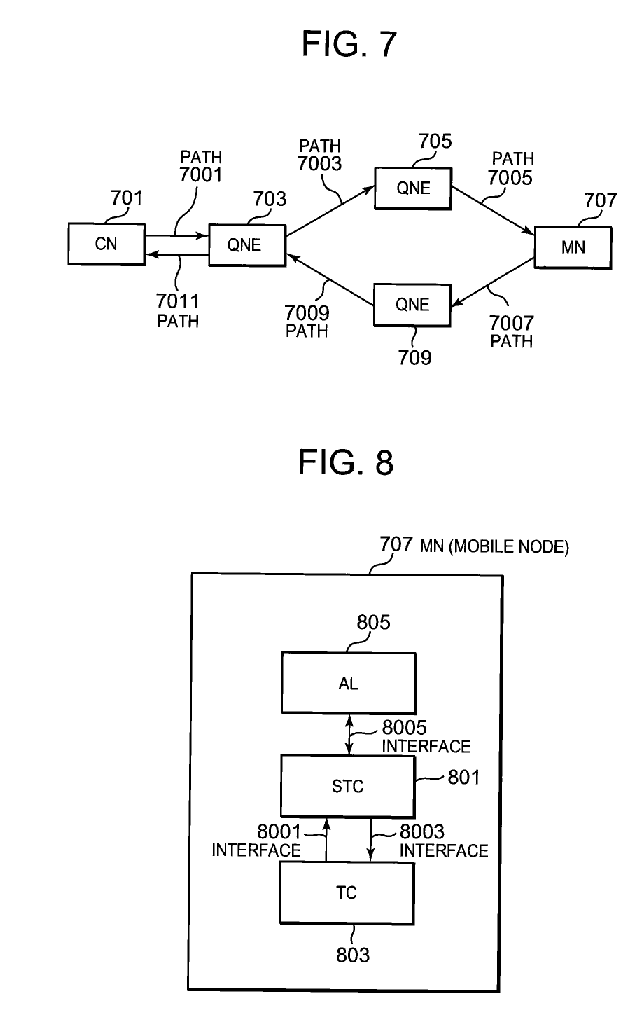

Next, a third embodiment of the present invention will be described. As described hereafter, precise numbers, time, structures, and parameters are provided to facilitate understanding of the present invention. However, it is clear to a person skilled in the art that the present invention is achieved without these precise details. A data communication system according to the third embodiment of the present invention is basically the same as the data communication system according to the first embodiment. However, the third embodiment will be described with reference to FIG. 7 to FIG. 11.

A communication session is present between a CN (equivalent to the terminal 106) 701 and a MN (equivalent to the terminal 100) 707 that are two end nodes. A data path from the CN 701 to the MN 707 is paths 7001, 7003, and 7005. The data path passes through a QNE 703 and a QNE 705 that are signaling nodes serving as crossover points. At the same time, a path from the MN 707 to the CN 701 is paths 7007, 7009, and 7011. The path passes through a QNE 709 and a QNE 703. In this case, the MN 707 is not a signaling-aware node (signaling aware node). A minimum number of nodes required to describe the problem are shown in FIG. 7. This is clear to a person skilled in the art. In an actual application, communication involves more nodes. Signaling-aware nodes and nodes that cannot process signaling are present. Two data paths in two directions may be assigned to nodes that are not shared. However, these do not affect general principle of the present invention.

FIG. 8 shows an example of a configuration of a MN supporting the third embodiment of the present invention. The MN 707 includes a signaling tunnel control (STC) 801, a transport control (TC) 803, and an application layer (AL) 805. The STC 801 is equivalent to an above-described processing means. An interface 8001 is used when the TC 803 passes a signaling message to the STC 801. An interface 8003 is used when the STC 801 passes a response message returned to the TC 803 for transmission. The AL 805 is equivalent to a function having a means to communicate with the CN 701. The AL 805 is an actual application related to the communication session, such as a signaling initiation protocol (SIP) signaling layer or a mobile IP layer. It is clear that these do not affect an operation principle of the present invention.

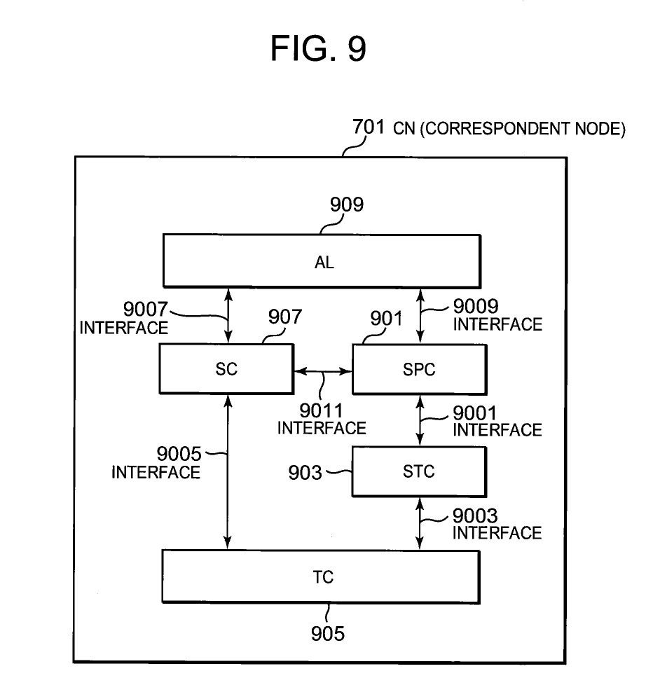

Next, an example of a configuration of a CN supporting the third embodiment of the present invention will be described with reference to FIG. 9. The CN 701 includes a signaling proxy control (SPC) 901, a signaling tunnel control (STC) 903, a transport control (TC) 905, a signaling control (SC) 907, and an application layer (AL) 909. The STC 903 is equivalent to an above-described message generating means.

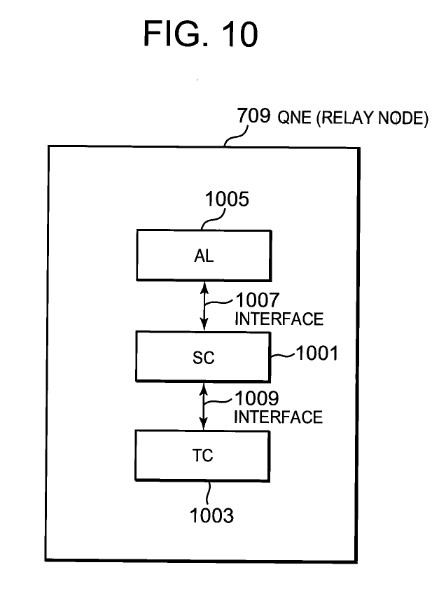

An example of a configuration of a QNE (relay node) supporting the third embodiment will be described with reference to FIG. 10. Because a plurality of QNE are present, the QNE 709 will be described as an example. The QNE 709 includes at least a signaling control (SC) 1001, a transport control (TC) 1003, and an application layer (AL) 1005. The SC 1001 and the AL 1005 are connected via an interface 1007. The SC 1001 and the TC 1003 are connected via an interface 1009. The SC 1001 is equivalent to an above-described message generating means and controlling means. However, the SC 1001 can be configured not to perform processes of the message generating means or processes of the controlling means, but rather such that individual constituent elements perform respective processes.

The AL 805 of the MN 707 and the AL 909 of the CN 701 establish a session. The session is, for example, a voice session based on SIP or a simple hyper text transfer protocol (HTTP) session. It is clear that the session type does not affect a principle of the present invention. Capabilities of communication nodes are negotiated during communication session set-up. For example, the SIP based on signaling provides capability negotiation. During processing, the AL 909 of the CN 701 finds that the MN 707 does not signaling capabilities. In this case, the AL 909 performs triggering and gives an address of the MN 707 to the SPC 901 of the CN 701, via the interface 9009. The SPC 901 proposes to the MN 707 that the CN 701 itself manage signaling (such as QoS signaling) as a proxy.

Because the MN 707 is not a signaling-aware node, the MN 707 cannot directly communicate with the SPC 901 using signaling messages. Therefore, the SPC 901 is required to use the STC 903 that establishes connection with the MN 707 to allow messages to be transmitted.

The SPC 901 gives the address of the MN 707 to the STC 903, via the interface 9001. The STC 903 uses a tunneling mechanism, such as IP and IPSec of IP tunneling. Such processes are light in load.

After receiving the address of the MN 707, the STC 903 generates a message for establishing a communication channel with the MN 707. For example, if the signaling is related to QoS, the message is QoS-Proxy-Invite. The message includes information required to establish a tunnel to the MN 707 to pass messages from the SPC 901, such as a port number or an encryption scheme.

The STC 903 passes the QoS-Proxy-Invite message to the TC 905 to transmit the message to the MN 707. The TC 905 is equivalent to a communication mechanism present between the CN 701 and the MN 707. The communication mechanism is, for example, a simple IP protocol, a mobile IP protocol, or a tunnel. It is clear that use of a different transmission mechanism does not affect the operation principle of the present invention.

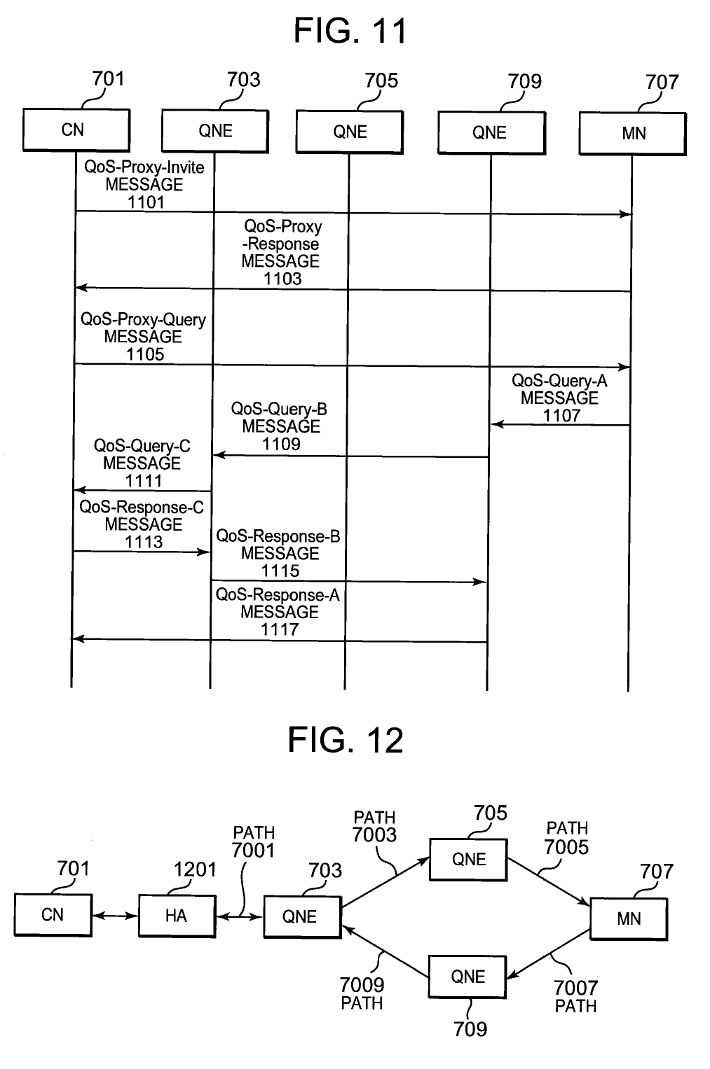

Here, with reference to FIG. 11, the TC 905 of the CN 701 sends a QoS-Proxy-Invite message 1101 to the MN 707. The message has an address of the CN 701 as an address of a transmitting source and the address of the MN 707 as an address of a transmitting destination. The message 1101 is directly sent from the CN 701 to the MN 707 like an ordinary data message between two communication nodes.

The TC 803 of the MN 707 receives the message 1101. When the TC 803 recognizes the message 1101 as the QoS-Proxy-Invite message, the TC 803 starts the STC 801 in response to the message. The TC 803 passes the message 1101 to the STC 801, via the interface 8001. The TC 803 uses different methods to identify the message 1101. For example, there is a method in which the message 1101 is determined by a port number, using a protocol ID, or a special flag. It is clear that the different methods of identifying the message do not affect the operation principle of the present invention.

Taking security into account, the QoS-Proxy-Invite message 1101 includes a security association used to prevent unauthenticated connection attempts and to protect message exchange, described hereafter. For example, the security association is established between the AL 805 of the MN 707 and the AL 909 of the CN 701 through application layer signaling. Information on the security association is given to the STC 801, via the interface 8005, and given to the STC 903, via the interface 9009 and the interface 9001. The QoS-Proxy-Invite message 1101 includes the security association such that the STC 801 can check the QoS-Proxy-Invite message 1101 and verify that the QoS-Proxy-Invite message 1101 is authentic. An example of information included in the QoS-Proxy-Invite message 1101 is as shown below.

$$QoS \text{-} Proxy \text{-} Invite := [ Tunnel Establish Info ] \\ [ Nonce \text{-} Cn ] \\ [ Authentication Code ]$$

Here, “Tunnel Establish Info” is information used when a tunnel is established between the MN 707 and the CN 701. The information includes, for example, a port number or an encryption scheme. “Nonce-CN” is a sufficiently large random number generated by the CN 701 and is used to establish a security key required for message verification and message exchange protection, described hereafter. “Authentication Code” is a verification code generated for the QoS-Proxy-Invite message 1101. The “Authentication Code” itself is included in values set in advance. For example, the STC 903 generates the “Authentication Code” using a hash function (such as Message Digest 5 [MD5]). Here, the key used is a combination of the security association established between the AL 909 and the AL 805 and the “Nonce-CN”. It is clear that other types of methods can be used to generate the “Authentication Code” without affecting the operation principle of the present invention.

After receiving the QoS-Proxy-Invite message 1101, the STC 801 first generates the “Authentication Code” for the received message using the same hash function and key. If the “Authentication Code” is the same, the STC 801 continues processing the message. Otherwise, the STC 801 destroys the message. Alternatively, if the AL 805 gives an instruction for notification, the STC 801 sends a response including an appropriate error code.

If the QoS-Proxy-Invite message 1101 passes the check, the STC 801 processes the “Tunnel Establish Info”. The STC 801 selects an appropriate tunneling scheme, encryption scheme, authentication scheme, or the like, based on, for example, the information included in the “Tunnel Establish Info”.

After processing, the STC 801 generates a response message, such as a QoS-Proxy-Response message 1103. Here, the QoS-Proxy-Response message 1103 includes information shown below.

$$QoS \text{-} Proxy \text{-} Response := [ Tunnel Establish Result ] \\ [ Nonce \text{-} MN ] \\ [ Authentication Code ]$$

Here, “Tunnel Establish Result” includes information related to tunnel establishment, such as a selected tunnel port, tunnel scheme, and encryption algorithm. “Nonce-MN” is a sufficiently large random number generated by the STC 801. The “Nonce-MN” is used to generate an “Authentication Code” and the key used to protect the message exchange, described hereafter. The “Authentication Code” is generated to resemble the “Authentication Code” of the QoS-Proxy-Invite message 1101. The key used to generate the “Authentication Code” is obtained from the “Non e-MN” and the security association from the AL 805.

The QoS-Proxy-Response message 1103 is directly sent from the MN 707 to the CN 701. When the STC 903 receives the QoS-Proxy-Response message 1103, the tunnel can be established between the CN 701 and the MN 707 if the “Authentication Code” is verified as being correct.

When the tunnel is established, the STC 903 sends a trigger to the SPC 901. The SPC 901 generates a QoS-Proxy-Query message 1105 and passes the message to the STC 903 to transmit to the MN 707. The STC 903 transfers the message directly to the MN 707 using the established tunnel.

Here, an example of the QoS-Proxy-Query is shown below.

$$QoS \text{-} Proxy \text{-} Query := [ Tunnel Header ] \\ [ Src := MN \text{-} Address ]$$

$$[ Dst := CN \text{-} Address ] \\ [ Extra \text{-} Src \text{-} Op := CN \text{-} Address ] \\ [ QoS \text{-} Query \text{-} Info ]$$

Here, “Tunnel Header” is header information required for message transmission between the CN 701 and the MN 707. It is clear that the information is dependent on the tunneling scheme selected by a procedure by which the QoS-Proxy-Invite message 1101 and the QoS-Proxy-Response message 1103 are exchanged. “Src” and “Dst” are respectively message transmitting source and transmitting destination addresses and are the address of the MN 707 and the address of the CN 701. “Extra-Src-Op” is a special option storing a current address and is the address of the CN 701. The address of “MN-Address” is used in the “Src” field in place of “CN-Address” to prevent network ingress filtering issues. The QoS-Proxy-Query message 1105 is encrypted when the message is transmitted through the tunnel. An encryption key is obtained from the QoS-Proxy-Invite message 1101 and the QoS-Proxy-Response message 1103. For example, the encryption key is composed of a security association function, “Nonce-CN”, and “Nonce-MN”.

When the STC 801 receives the QoS-Proxy-Query message 1105, the STC 801 removes the “Tunnel Header” and passes the remaining message directly to the TC 803 to send as a QoS-Query-A message 1107. The QoS-Query-A message 1107 has a following structure.

$$QoS \text{-} Query \text{-} A := [ Src := MN \text{-} Address ]$$

$$[ Dst := CN \text{-} Address ] \\ [ Extra \text{-} Src \text{-} Op := CN \text{-} Address ] \\ [ QoS \text{-} Query \text{-} Info ]$$

The message is viewed as an ordinary signaling message by an intermediate node and flows through the data path from the MN 707 to the CN 701.

Therefore, the QoS-Query-A message 1107 is intercepted by a signaling-aware node, such as the QNE 709. After the QNE 709 receives the message, the QNE 709 processes the message as an ordinary signaling message. When an ordinary signaling scheme, such as NSIS, is used, the QNE 709 is required to establish a reverse message association. The QNE 709 acquires the address stored in the “Extra-Src-Op” field as a previous hop address. In this case, the QNE 709 then generates a special routing state. In other words, the routing state is “regarding signaling session from MN-Address to CN-Address, Previous-hop:=CN-Address”. The signaling message sent in the opposite direction is transmitted from the QNE 709 to the CN 701 through this method.

After processing, the QNE 709 updates the “QoS-Query-Info” field and transfers the message to the address indicated in the “Dst” field, namely the address of the CN 701. At the same time, the QNE 709 checks the “Extra-Src-Op” field and rewrites the address in the field with its own address. As a result, a transferred QoS-Query-B message 1109 is as shown below.

$$QoS \text{-} Query \text{-} B := [ Src := MN \text{-} Address ]$$

$$[ Dst := CN \text{-} Address ] \\ [ Extra \text{-} Src \text{-} Op := QNE 709 \text{-} Address ] \\ [ QoS \text{-} Query \text{-} Info ]$$

The QoS-Query-B message 1109 flows in the same manner as the data flow from the MN 707 to the CN 701. Therefore, the QoS-Query-B message 1109 is once again intercepted by the signaling-aware node on the path, QNE 703. The QNE 703 processes the message in adherence to an ordinary signaling procedure. For example, the QNE 703 updates the corresponding “QoS-Query-Info” field. Similarly, the QNE 703 establishes reverse-direction message routing in adherence to the “Extra-Src-Op”. In other words, the established routing is directed towards QNE 709.

After processing, the QNE 703 transfers the Query message towards the address indicated by “Dst”, namely the address of the CN 701. At the same time, the QNE 703 checks the “Extra-Src-Op” field. The QNE 703 updates the “Extra-Src-Op” field with its own address. Then, a QoS-Query-C message 1111 that is a new message to be transferred is as shown below.

$$QoS \text{-} Query \text{-} C := [ Src := MN \text{-} Address ] \\ [ Dst := CN \text{-} Address ] \\ [ Extra \text{-} Src \text{-} Op := QNE 703 \text{-} Address ] \\ [ QoS \text{-} Query \text{-} Info ]$$

When the TC 905 of the CN 701 receives the QoS-Query-C message 1111, the TC 905 passes the message to the SC 907 via the interface 9005. An ordinary signaling process is applied to the message. At the same time, the CN 701 establishes a reverse signaling message routing towards the QNE 703 in adherence to the “Extra-Src-Op”.

After processing, the SC 907 decides to send a response to the Query message. The SC 907 generates a QoS-Response-C message 1113. An example of the QoS-Response-C message is shown below.

$$QoS \text{-} Response \text{-} C := [ Src := CN \text{-} Address ]$$

$$[ Dst := QNE 703 \text{-} Address ] \\ [ Extra \text{-} Dst \text{-} Op := MN \text{-} Address ] \\ [ QoS \text{-} Response \text{-} Info ]$$

Here, “QoS-Response-Info” includes information required for signaling response. The QoS-Response-C message 1113 is clearly transmitted for each hop based on the information on the reverse routing established by the QoS-Query-C message 1111 that is a Query message. “Extra-Dst-Op” indicates a final destination of the signaling message and the direction of signaling.

When the signaling-aware node, QNE 703, receives the QoS-Response-C message 1113, the QNE 703 processes the message in adherence to the ordinary signaling procedure. At the same time, the QNE 703 transfers the Response message because the “Extra-Dst-Op” indicates the address of the MN 707 that is not equal to its own address. Therefore, the QNE 703 checks a reverse routing table and finds that the previous hop is QNE 709. QoS-Response-B message 1115 that is a new message is transmitted to the QNE 709. The transmitted QoS-Response-B message 115 is as shown below.

$$QoS \text{-} Response \text{-} B := [ Src := QNE 703 \text{-} Address ]$$

$$[ Dst := QNE 709 \text{-} Address ] \\ [ Extra \text{-} Src \text{-} Op := MN \text{-} Address ] \\ [ QoS \text{-} Response \text{-} Info ]$$

Here, when the message reaches the QNE 709, the QNE 709 processes the message in adherence to the ordinary signaling procedure. The QNE 709 decides to further transfer the Response because “Extra-Src-Op” differs from its own address. The QNE 709 checks reverse routing at a previous hop that is the CN 701. Therefore, QoS-Response-A message 1117 that is a new message is as shown below.

$$QoS \text{-} Response \text{-} A := [ Src := QNE 709 \text{-} Address ] \\ [ Dst := CN \text{-} Address ] \\ [ Extra \text{-} Dst \text{-} Op := MN \text{-} Address ] \\ [ QoS \text{-} Response \text{-} Info ]$$

The QoS-Response-A message 1117 is transmitted directly from the QNE 709 to the CN 701. When the TC 905 receives the message, the TC 905 passes the message to the 907, via the interface 9005. The SC 907 checks the “Extra-Dst-Op” field. Because the “Extra-Dst-Op” field is equal to the address of the MN 707, the message is passed to the SPC 901, via the interface 9011. The SPC 901 processes the signaling message for the MN 707.

In subsequent signaling message exchanges in the session as well, the same processing as that for the above-described QoS-Query messages and QoS-Response messages is performed. In this method, the MN 707 is not required to be capable of processing signaling. The MN 707 is required to move the STC 801, an operation that is a very light in load. The STC 801 receives a message from the CN 701 through the established tunnel and transfers the message after removing the header. Signaling states and processes are not required in the MN 707. Therefore, very little resources are required and the present invention is suitable for a mobile device.

### Fourth Embodiment

According to the third embodiment, the SPC 901 always transmits a message to the STC 801 of the MN 707, via the STC 903. However, as shown in FIG. 11, between the QoS-Query-A message 1107 and the QoS-Response-A message 1117, the SPC 901 has already acquired information on the address of the signaling-aware node of the next hop, such as information on the address of the QNE 709. To simplify processing, the STC 901 can transmit the message directly to the QNE 709 instead, after the first QoS-Query and QoS-Response exchange.

In this case, the SPC 901 passes the message to the 907, via the interface 9011, and further passes the message to the TC 905, via the interface 9005. The message has a following format.

$$QoS \text{-} Signal \text{-} Msg := [ Src := CN \text{-} Address ] \\ [ Dst := QNE 709 \text{-} Address ] \\ [ Extra \text{-} Dst \text{-} Op := CN \text{-} Address ] \\ [ QoS \text{-} Signal \text{-} Info ]$$

In this way, the message is transmitted directly from the CN 701 to the QNE 709 without passing through the MN 707. This reduces signaling load placed on a mobile device.

### Fifth Embodiment

A fifth embodiment of the present invention will be described with reference to FIG. 12. As shown in FIG. 12, according to the fifth embodiment, a home agent (HA) 1201 is present between the CN 701 and the QNE 703 in the data communication system according to the third embodiment. According to the fifth embodiment, the HA 1201 operates as the proxy for the MN 707. When the HA 1201 receives a binding update (BU) from the MN 707, the HA 1201 transmits the QoS-Proxy-Query message towards the MN 707 as according to the third embodiment. The HA 1201 performs the above-described processing procedure performed by the CN 701 according to the third embodiment. A path between the HA 1201 and the MN 707 is an aggregation of a number of flows and is managed by the HA 1201.

The CN 701 can still transmit the QoS-Proxy-Query message. At this time, because a tunnel is used between the HA 1201 and the MN 707, the resulting Query is only viewed by nodes subsequent to those between the CN 701 and the HA 1201. This operation is performed when nesting is used.

### Sixth Embodiment

According to a sixth embodiment, when the terminal 100, the terminal 400, and the MN 707 according to the above-described first to fifth embodiments perform a handover will be described. Three patterns will be described below. When the three patterns are described, the terminal 100, the terminal 400, and the MN 707 are described as a MN 1300. The terminal 106, the terminal 406, and the CN 701 are described as a CN 1301.

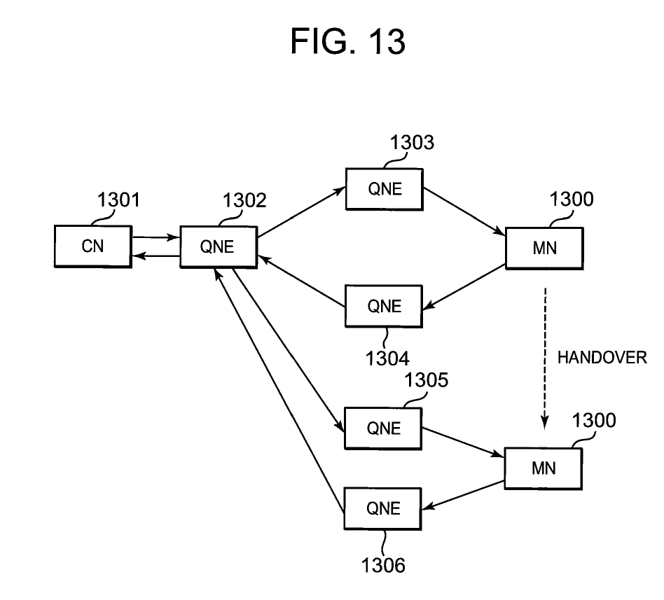

First, a first pattern will be described with reference to FIG. 13. In the first pattern, the MN 1300 having a single interface performs the handover. After the proxy serving as the proxy for the MN 1300 is discovered as described according to the first to fifth embodiments, the MN 1300 performs the handover. Before the handover, the MN 1300 communicates with the CN 1301 via a QNE 1302, a QNE 1303, and a QNE 1304.

When the MN 1300 starts the handover, the MN 1300 communicates with the CN 1301 via the QNE 1302, a QNE 1305, and a QNE 1306. Signaling and sequence for proxy retrieval at a handover destination are as described according to the first to fifth embodiments. The same processes are performed at the handover destination of the MN 1300.

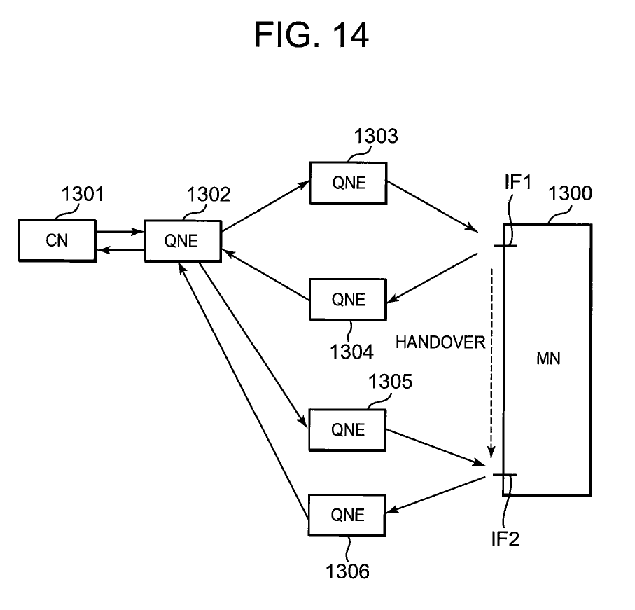

Next, a second pattern will be described with reference to FIG. 14. In the second pattern, the MN 1300 having a plurality of interfaces (two, herein) performs the handover between the interfaces. After the proxy serving as the proxy for the MN 1300 is discovered as according to the first to fifth embodiments, the MN 1300 performs the handover between the interfaces. In other words, as shown in FIG. 14, the MN 1300 performs the handover from an interface (IF1) to an interface (IF2). Before performing the inter-interface handover, the MN 1300 communicates with the CN 1301, via the QNE 1302, the QNE 1303, and the QNE 1304 using the IF1.

When the MN 1300 starts the inter-interface handover, the MN 1300 communicates with the CN 1301, via the QNE 1302, the QNE 1305, and the QNE 1306, using the IF2. At this time, the MN 1300 updates the interface from the IF1 to the IF2 by performing the handover. Signaling and sequence for proxy retrieval at an inter-interface handover destination are as described according to the first to fifth embodiments. The same processes are performed at the inter-interface handover destination of the MN 1300.

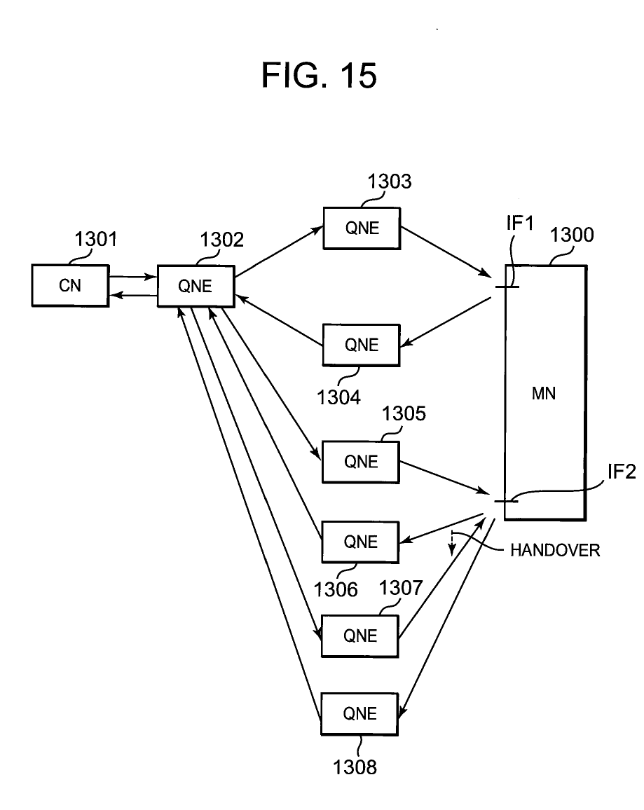

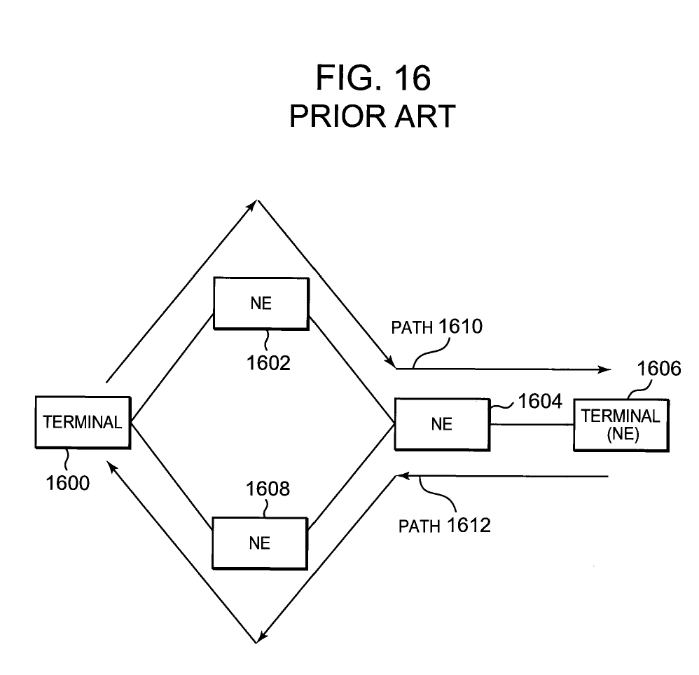

Next, a third pattern will be described with reference to FIG. 15. In the third pattern, one interface of the MN 1300 having a plurality of interfaces (two, herein) performs the handover. After the proxy serving as the proxy for the MN 1300 is discovered as according to the first to fifth embodiments, the interface, such as the IF2, of the MN 1300 performs the handover. Before the handover, the MN 1300 communicates with the CN 1301, via the QNE 1302, the QNE 1303, and the QNE 1304, using the IF1. The MN 1300 also communicates with the CN 1301, via the QNE 1302, the QNE 1305, and the QNE 1306, using the IF2.

After the IF2 of the MN 1300 starts the handover, the MN 1300 communicates with the CN 1301, via the QNE 1302, the QNE 1307, and the QNE 1308, using the IF2. Signaling and sequence for proxy retrieval at the IF2 handover destination are as described according to the first to fifth embodiments. The same processes are performed at the IF2 handover destination.

In the signaling when the MN 1300 has a plurality of interfaces, a path-type ID (refer to Non-patent Document 7) is added in addition to the session ID and a flow ID. Through use of the path-type ID, signaling within a same session are individually managed.

Each functional block used in the explanations of each embodiment of the present embodiment, described above, can be realized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed after LSI manufacturing or a reconfigurable processor of which connections and settings of the circuit cells within the LSI can be reconfigured can be used. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The proxy node discovering method and the relay node used in the method of the present invention can decide the proxy even when a local technology is not present between the data transmitter and the proxy or between the application and the proxy. The node discovering method and the first node, the second node, and the relay node used in the method of the present invention can decide the node adjacent to the data transmitter even when a local technology is not present between the data transmitter and the adjacent node. Therefore, the proxy node discovering method, and the relay node used in the method, and, node discovering method, and the first node, the second node and the relay node used in the method are advantageous for a node discovering method and a relay node used in the method, in which the proxy node discovering method decides a proxy node (proxy) that processes a certain signaling message as a proxy for a data transmitting and receiving terminal that cannot process the certain signaling message, and a node discovering method and a first node, a second node, and a relay node used in the method, in which the node discovering method discovers a node that serves as a correspondence partner when one data transmitting and receiving terminal operates as a proxy for a data transmitting and receiving terminal that cannot process a certain signaling message.

1. A proxy node discovering method in which, in a data communication system including a first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a proxy node positioned on the first path that processes the message having the predetermined property as a proxy for the second node is discovered, the proxy node discovering method comprising a step of:
transmitting towards the second node, by the first node, a first message that is the message having the predetermined property to which information indicating that discovery of the proxy node is requested is added;
judging, by the relay node that has received the first message, whether the relay node itself is a relay node positioned closest to the second node on the second path;
transmitting via the second node, by the relay node that has judged that the relay node itself is the relay node positioned closest to the second node on the second path, a second message that is the message having the predetermined property to which information indicating that a relay node adjacent to the relay node itself on the first path is being discovered is added; and
acquiring, by the relay node that has transmitted the second message, information identifying a relay node that is first to receive the transmitted second message from the relay node that is first to receive the second message.

2. The proxy node discovering method according to claim 1, wherein:
the first message is a message indicating that discovery of a relay node positioned closest to the second node on the first path that can process the message having the predetermined property is requested and includes address information of the second node.

3. The proxy node discovering method according to claim 1, wherein:
the relay node that transmits the second message or the relay node that is first to receive the second message transmits to the first node a third message that is the message having the predetermined property to which information identifying the relay node that is first to receive the second message is added.

4. The proxy node discovering method according to claim 1, wherein:
the first message is a message indicating that discovery of a relay node positioned closest to the second node on the first path that can process the message having the predetermined property is requested and a message indicating that a Quality of Service resource reservation on the first path is requested of the discovered relay node, and includes at least one or more among address information of the second node, address information of the first node, and information on the Quality of Service resource reserved on the first path.

5. The proxy node discovering method according to claim 1, wherein:
the second message is a message indicating that a Quality of Service resource reservation on the first path is requested of the relay node that is first to receive the second message and includes at least one or more between address information of the first node and information on the Quality of Service resource reserved on the first path.

6. The proxy node discovering method according to claim 1, wherein:
the first message and the second message include information used to allow the relay node that can process the message having the predetermined property to receive the first message and the second message.

7. The proxy node discovering method according to claim 1, wherein:
when the second node moves after the proxy node is discovered, the proxy node at a destination of the movement can be rediscovered.

8. A relay node that, in a data communication system including a first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, can process the message having the predetermined property, the relay node comprising:
a receiving means that receives a first message transmitted from the first node that is the message having the predetermined property to which information indicating that discovery of the proxy node is requested is added;
a judging means that, based on the received first message, judges whether the relay node itself is a relay node positioned closest to the second mode on the second path;
a message generating means that, when the relay node itself is judged to be the relay node positioned closest to the second node on the second path, generates a second message that is the message having the predetermined property to which information indicating that a relay node adjacent to the relay node itself on the first path is being discovered is added;
a transmitting means that transmits the generated second message via the second node; and
an acquiring means that acquires information identifying a relay node that is first to receive the transmitted second message from the relay node that is first to receive the second message.

9. The relay node according to claim 8, wherein:
the first message is a message indicating that discovery of a relay node positioned closest to the second node on the first path that can process the message having the predetermined property is requested and includes address information of the second node.

10. The relay node according to claim 8, wherein:
the acquiring means acquires information related to the relay node that is first to receive the second message from the relay node that is first to receive the second message;
the message generating means generates a third message that is the message having the predetermined property to which the acquired information identifying the relay node is included; and
the transmitting means transmits the generated third message to the first node.

11. The relay node according to claim 8, wherein:
the first message is a message indicating that discovery of a relay node positioned closest to the second node on the first path that can process the message having the predetermined property is requested and a message indicating that a Quality of Service resource reservation on the first path is requested of the discovered relay node, and includes at least one or more among address information of the second node, address information of the first node, and information on the Quality of Service resource reserved on the first path.

12. The relay node according to claim 8, wherein:
the second message is a message indicating that a Quality of Service resource reservation on the first path is requested of the relay node that is first to receive the second message and includes at least one or more between address information of the first node and information on the quality of service resource reserved on the first path.

13. The relay node according to claim 8, wherein:
the first message and the second message include information used to allow the relay node that can process the message having the predetermined property to receive the first message and the second message.

14. A node discovering method in which, in a data communication system including a first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a node positioned closest to the second node on the first path and that can process the message having the predetermined property is discovered, the node discovering method comprising a step of:
transmitting towards the second node, by the first node, a message used to discover the node positioned closest to the second node on the first path; and
receiving, by the first node, based on the message transmitted via the second node, information identifying the node positioned closest to the second node on the first path included in a message transmitted from the node itself.

15. A node discovering method in which, in a data communication system including a first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a node positioned closest to the second node on the first path and that can process the message having the predetermined property is discovered, the node discovering method comprising a step of:
transmitting towards the second node, by the first node, a first message proposing that the first node itself become a proxy node operating as a proxy for the second node;
transmitting towards the first node, by the second node, a portion of the received first message as a second message, when the first node is accepted as the proxy node based on the received first message; and
transmitting towards the first node, by the relay node that has received the second message transmitted by the second node, the second message including information used to identify the relay node itself.

16. The node discovering method according to claim 15, wherein:
the first message includes at least address information of the second node as a transmitting source address, address information of the first node as a transmitting destination address, and address information of a node that is an actual transmitting source, and is encapsulated by predetermined header information.

17. The node discovering method according to claim 16, wherein:
the second node removes the predetermined header information in the first message and transmits remaining first message towards the first node as the second message.

18. The node discovering method according to claim 16, wherein:
the relay node that has received the second message acquires address information of a hop node that is an adjacent node on the first path that has transmitted the second message, based on the address information of the node that is the actual transmitting source included in the second message, and changes the address information of the node that is the actual transmitting source included in the second message to address information of the relay node itself.

19. The node discovering method according to claim 15, wherein:
when the second node moves, the first node transmits the first message again to towards the second node.

20. A first node that is used in a node discovering method in which, in a data communication system including the first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a node positioned closest to the second node on the first path and that can process the message having the predetermined property is discovered, the first node comprising:
a message generating means that generates a first message used to propose that the first node itself become a proxy node operating as a proxy for the second node; and
a transmitting means that transmits the generated first message towards the second node.

21. The first node according to claim 20, wherein:
the first message includes at least address information of the second node as a transmitting source address, address information of the first node as a transmitting destination address, and address information of a node that is an actual transmitting source, and is encapsulated by predetermined header information.

22. The first node according to claim 20, wherein:
when the second node moves, the transmitting means transmits the first message again towards the second node.

23. A second node that is used in a node discovering method in which, in a data communication system including a first node that transmits and receives data, the second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a node positioned closest to the second node on the first path and that can process the message having the predetermined property is discovered, the second node comprising:
a receiving means that receives a first message transmitted by the first node proposing that the first node become a proxy node operating as a proxy for the second node;
a processing means that, when the first node is accepted as the proxy node based on the received first message, processes a portion of the received first message into a second message; and
a transmitting means that transmits the processed second message towards the first node.

24. The second node according to claim 23, wherein:
the first message includes at least address information of the second node as a transmitting source address, address information of the first node as a transmitting destination address, and address information of a node that is an actual transmitting source, and is encapsulated by predetermined header information.

25. The second node according to claim 24, wherein:
the processing means removes the predetermined header information in the first message and generates the second message.

26. The second node according to claim 23, wherein:
when the second node itself moves, the transmitting means transmits a message towards the first node giving notification that the second node itself has moved, to receive the first message again from the first node.

27. A relay node used in a node discovering method in which, in a data communication system including a first node that transmits and receives data, a second node that is a correspondence partner of the first node, and a plurality of relay nodes that relay data transmitted and received between the first node and the second node, in which data from the second node to the first node passes through a first path and data from the first node to the second node passes through a second path, and the first node and at least one or more relay nodes among the relay nodes can receive and process a message having a predetermined property, a node positioned closest to the second node on the first path and that can process the message having the predetermined property is discovered, the relay node comprising:
a receiving means that receives a second message transmitted by the second node that is a portion of a first message from the first node proposing to become a proxy node operating as a proxy for the second node;
a message generating means that includes information used to identify the relay node itself in the received second message; and
a transmitting means that transmits the generated second message towards the first node.

28. The relay node according to claim 27, wherein:
the first message includes at least address information of the second node as a transmitting source address, address information of the first node as a transmitting destination address, and address information of a node that is an actual transmitting source, and is encapsulated by predetermined header information.

29. The relay node according to claim 28 further comprises:
a controlling means that, based on the address information of the node that is the actual transmitting source included in the second message, acquires address information of a hop node that is an adjacent node on the first path that has transmitted the second message, and changes the address information of the node that is the actual transmitting source included in the second message to address information of the relay node itself.
